(19) United States
(12) Patent Application Publication
(10) Pub. No.: US 2024/0357706 A1
(43) Pub. Date: Oct. 24, 2024

(54) COMMUNICATION METHOD

(71) Applicant: KYOCERA CORPORATION, Kyoto (JP)

(72) Inventors: Masato FUJISHIRO, Yokohama-shi (JP); Henry CHANG, San Diego, CA (US)

(73) Assignee: KYOCERA CORPORATION, Kyoto (JP)

(21) Appl. No.: 18/763,071

(22) Filed: Jul. 3, 2024

Related U.S. Application Data
(63) Continuation of application No. PCT/JP2022/046504, filed on Dec. 16, 2022.
(60) Provisional application No. 63/296,237, filed on Jan. 4, 2022.

(51) Int. Cl. H04W 76/40; H04W 76/11; H04W 76/27

(52) U.S. Cl. CPC H04W 76/40; H04W 76/11; H04W 76/27

(57) ABSTRACT

A communication method performed by a UE in a mobile communication system for providing a multicast and broadcast service (IBS) includes: receiving or being interested in receiving an MBS session provided in an initial bandwidth part of a serving cell or in a neighboring cell when in an RRC idle state or an RRC inactive state in the serving cell; and transmitting an MBS interest indication regarding the IBS session to the serving cell when transitioning from the RRC idle state or the RRC inactive state to an RRC connected state. The MBS interest indication does not include an MBS session identifier indicating the MBS session and includes frequency information regarding the initial bandwidth part or a cell identifier of the neighboring cell.

### RELATED APPLICATIONS

The present application is a continuation based on PCT Application No. PCT/JP2022/046504, filed on Dec. 16, 2022, which claims the benefit of U.S. Provisional Patent Application No. 63/296,237 filed on Jan. 4, 2022. The content of which is incorporated by reference herein in their entirety.

### TECHNICAL FIELD

The present disclosure relates to a communication method used in a mobile communication system.

### BACKGROUND

In 3rd Generation Partnership Project (3GPP) standards, technical specifications of New Radio (NR) being radio access technology of the fifth generation (5G) have been defined. NR has features such as high speed, large capacity, high reliability, and low latency, in comparison to Long Term Evolution (LTE) being radio access technology of the fourth generation (4G). In 3GPP, there have been discussions for establishing technical specifications of multicast and broadcast services (MBS) of 5G/NR (for example, see Non-Patent Document 1).

### CITATION LIST

### Non-Patent Literature

Non-Patent Document 1: 3GPP Contribution: RP-201038, “WID revision: NR Multicast and Broadcast Services”

### SUMMARY

5G/NR multicast and broadcast services are desired to provide enhanced services compared to 4G/LTE multicast and broadcast services.

In view of this, the present disclosure provides a communication method for enabling implementation of enhanced multicast and broadcast services.

A communication method according to a first aspect is a communication method performed by a user equipment in a mobile communication system for providing a multicast and broadcast service (MBS), the communication method including: receiving or being interested in receiving an MBS session provided in an initial bandwidth part of a serving cell or in a neighboring cell when in an RRC idle state or an RRC inactive state in the serving cell; and transmitting an MBS interest indication regarding the MBS session to the serving cell when transitioning from the RRC idle state or the RRC inactive state to an RRC connected state. The MBS interest indication does not include an MBS session identifier indicating the MBS session and includes frequency information regarding the initial bandwidth part or a cell identifier of the neighboring cell.

A communication method according to a second aspect is a communication method performed by a user equipment in a mobile communication system for providing a multicast and broadcast service (IBS), the communication method including: receiving or being interested in receiving a broadcast session when in an RRC idle state or an RRC inactive state in a serving cell; transmitting an IBS interest indication regarding the broadcast session to the serving cell at a time of transition from the RRC idle state or the RRC inactive state to an RRC connected state when the broadcast session is provided from the serving cell; and omitting transmission of the IBS interest indication to the serving cell at a time of the transition to the RRC connected state when the broadcast session is provided from a non-serving cell.

A communication method according to a third aspect is a communication method performed by a user equipment in a mobile communication system for providing a multicast and broadcast service (IBS), the communication method including: receiving or being interested in receiving a broadcast session transmitted in an initial bandwidth part of a serving cell when in an RRC idle state or an RRC inactive state in the serving cell; receiving, from the serving cell, a message configuring a dedicated bandwidth part different from the initial bandwidth part for the user equipment when transitioning from the RRC idle state or the RRC inactive state to an RRC connected state; and continuing use of the initial bandwidth part without applying a configuration of the dedicated bandwidth part even when the message is received.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to the embodiment.

FIG. 3 is a diagram illustrating a configuration of a gNB (base station) according to the embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating an overview of IBS traffic delivery according to the embodiment.

FIG. 7 is a diagram illustrating delivery modes according to the embodiment.

FIG. 8 is a diagram illustrating an example of internal processing related to MBS reception of the UE according to the embodiment.

FIG. 9 is a diagram illustrating another example of the internal processing related to the MBS reception of the UE according to the embodiment.

FIG. 10 is a diagram for describing an overview of a CFR.

FIG. 11 is a diagram illustrating an operation example of the mobile communication system according to the embodiment.

FIG. 12 is a diagram illustrating an operation example of a UE according to Variation 1.

FIG. 13 is a diagram illustrating an operation example of a mobile communication system according to Variation 2.

FIG. 14 is a diagram illustrating an operation example of a mobile communication system according to Variation 3.

### DESCRIPTION OF EMBODIMENTS

A mobile communication system according to an embodiment is described with reference to the drawings. In the description of the drawings, the same or similar parts are denoted by the same or similar reference signs.

### Configuration of Mobile Communication System

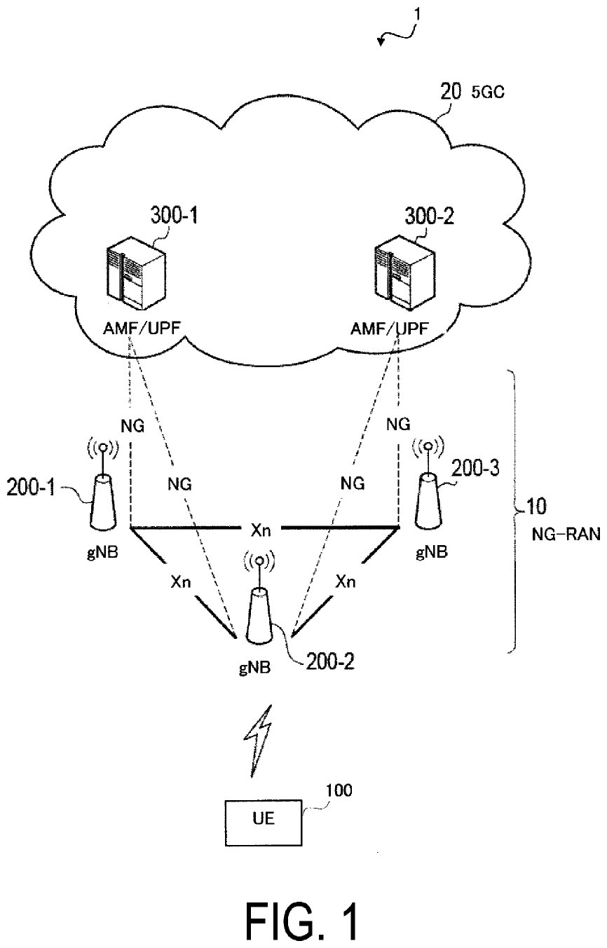

FIG. 1 is a diagram illustrating a configuration of a mobile communication system according to an embodiment. A mobile communication system 1 complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided at a sensor, a vehicle or an apparatus provided at a vehicle (Vehicle UE), and a flying object or an apparatus provided at a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) being a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility control and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

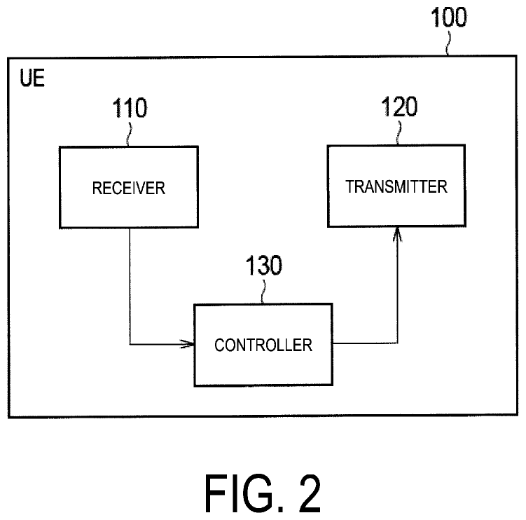

FIG. 2 is a diagram illustrating a configuration of the UE 100 (user equipment) according to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of each layer described below. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

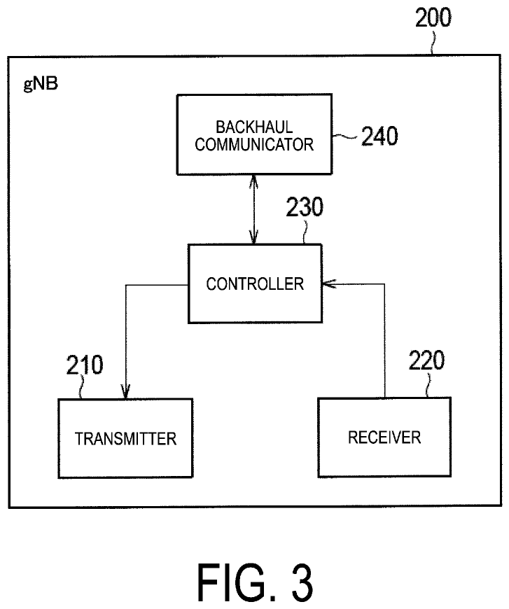

FIG. 3 is a diagram illustrating a configuration of the gNB 200 (base station) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of each layer described below. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface, which is an inter-base station interface. The backhaul communicator 240 is connected to the AMF/UPF 300 via a NG interface, which is an interface between the base station and the core network. Note that the gNB 200 may include a Central Unit (CU) and a Distributed Unit (DU) (i.e., functions are divided), and the two units may be connected via an F1 interface, which is a fronthaul interface.

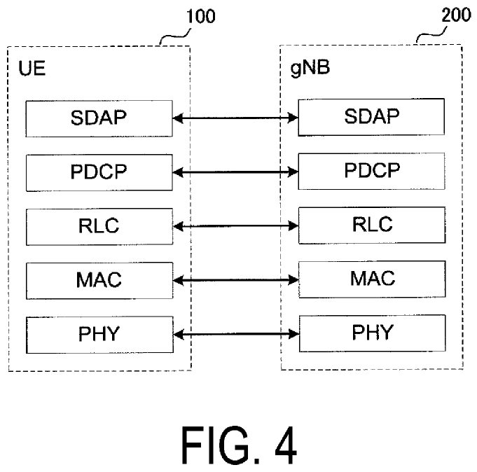

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (Hybrid Automatic Repeat reQuest (HARQ)), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

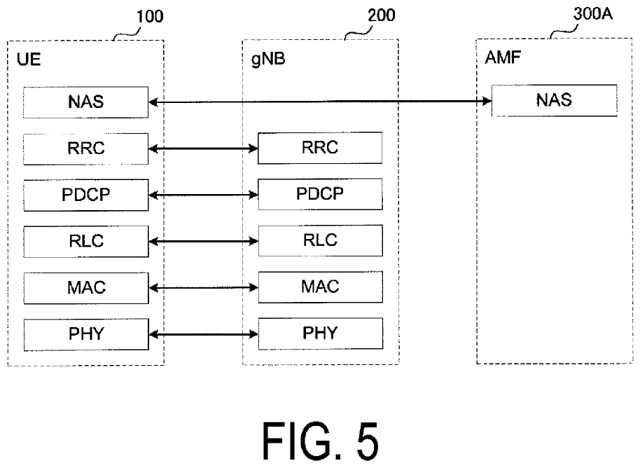

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When connection (RRC connection) between the RRC of the UE 100 and the RRC of the gNB 200 is made, the UE 100 is in an RRC connected state. When no connection (RRC connection) between the RRC of the UE 100 and the RRC of the gNB 200 is made, the UE 100 is in an RRC idle state. When connection between the RRC of the UE 100 and the RRC of the gNB 200 is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. A layer lower than the NAS layer is referred to as an AS layer.

### Overview of MBS

An overview of an MBS according to the embodiment will be provided. The MBS is a service enabling data transmission from the NG-RAN 10 to the UE 100 in a broadcast or multicast manner, i.e., a Point To Multipoint (PTM) manner. Assumed use cases (service types) of the MBS include public safety communication, mission critical communication, Vehicle to Everything (V2X) communication, IPv4 or IPv6 multicast delivery, Internet protocol television (IPTV), group communication, and software delivery.

A broadcast service provides a service to every UE 100 within a particular service area for an application not requiring highly reliable QoS. An MBS session used for the broadcast service is referred to as a broadcast session.

A multicast service provides a service not to every UE 100, but to a group of UEs 100 joining the multicast service (multicast session). An MBS session used for the multicast service is referred to as a multicast session. The multicast service can provide the same content to the group of UEs 100 through a method with higher radio efficiency than the broadcast service.

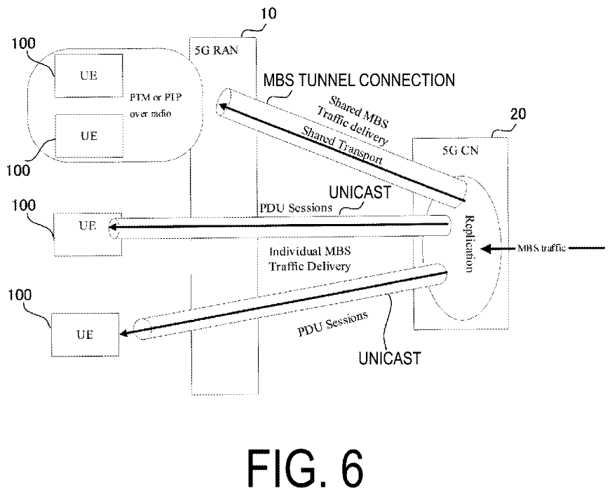

FIG. 6 is a diagram illustrating an overview of MBS traffic delivery according to the embodiment.

MBS traffic (MBS data) is delivered from a single data source (application service provider) to a plurality of UEs. The 5G CN (5GC) 20, which is a 5G core network, receives the MBS data from the application service provider and performs Replication of the MBS data to deliver the resultant data.

From the perspective of the 5GC 20, two multicast delivery methods are possible: 5GC Shared MBS Traffic delivery and 5GC Individual MBS Traffic delivery.

In the 5GC individual MBS traffic delivery method, the 5GC 20 receives a single copy of MBS data packets and delivers individual copies of these MBS data packets to the individual UEs 100 via PDU sessions of the individual UEs 100. Thus, one PDU session for each UE 100 needs to be associated with a multicast session.

In the 5GC shared MBS traffic delivery method, the 5GC 20 receives a single copy of MBS data packets and delivers the single copy of the MBS packets to a RAN node (i.e., the gNB 200). The gNB 200 receives the MBS data packets via MBS tunnel connection, and delivers those packets to one or more UEs 100.

From the perspective of the RAN (5G RAN) 10, two delivery methods are possible for radio transmission of the MBS data in the 5GC shared MBS traffic delivery method: a Point-to-Point (PTP) delivery method and a Point-to-Multipoint (PTM) delivery method. PTP means unicast, and PTM means multicast and broadcast.

In the PTP delivery method, the gNB 200 wirelessly delivers the individual copies of the MBS data packets to the individual UEs 100. On the other hand, in the PTM delivery method, the gNB 200 wirelessly delivers the single copy of the MBS data packets to a group of the UEs 100. The gNB 200 can dynamically determine whether to use the PTM or PTP delivery method as a method for delivering the MBS data to one UE 100.

The PTP and PTM delivery methods are mainly related to the user plane. Modes for controlling the MBS data delivery include two delivery modes: a first delivery mode and a second delivery mode.

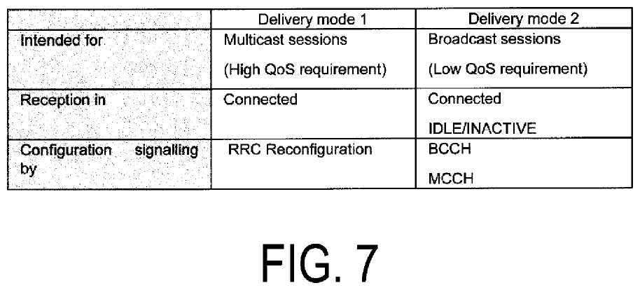

FIG. 7 is a diagram illustrating delivery modes according to the embodiment.

The first delivery mode (Delivery mode 1 (DM1)) is a delivery mode that can be used by the UE 100 in the RRC connected state, and is a delivery mode for high QoS requirements. The first delivery mode is used for multicast sessions among MBS sessions. Note that the first delivery mode may be used for broadcast sessions. The first delivery mode may be available to the UE 100 in the RRC idle state or the RRC inactive state.

An MBS reception configuration in the first delivery mode is performed through UE-dedicated signaling. For example, the MBS reception configuration in the first delivery mode is performed through an RRC Reconfiguration message (or an RRC Release message), which is an RRC message unicast from the gNB 200 to the UE 100.

The MBS reception configuration includes MBS traffic channel configuration information (hereinafter referred to as “MTCH configuration information”) about configuration of an MBS traffic channel transmitting MBS data. The MTCH configuration information includes MBS session information (including an MBS session identifier described below) relating to an MBS session and scheduling information of the MBS traffic channel corresponding to the MBS session. The scheduling information of the MBS traffic channel may include discontinuous reception (DRX) configuration of the MBS traffic channel. The discontinuous reception configuration may include at least one parameter selected from the group consisting of a timer value (On Duration Timer) for defining an on-period (On Duration: reception period), a timer value (Inactivity Timer) for extending the on-period, a scheduling interval or a DRX cycle (Scheduling Period, DRX Cycle), an offset value (Start Offset, DRX Cycle Offset) of a start subframe for scheduling or a DRX cycle, a start delay slot value (Slot Offset) of an on-period timer, a timer value (Retransmission Timer) for defining a maximum time until retransmission, and a timer value (HARQ RTT Timer) for defining a minimum interval until DL assignment of HARQ retransmission.

Note that the MBS traffic channel is a type of logical channel and may be referred to as an MTCH. The MBS traffic channel is mapped to a downlink shared channel (Down Link-Shared CHannel (DL-SCH)) being a type of transport channel.

The second delivery mode (Delivery mode 2 (DM2)) is a delivery mode that can be used not only by the UE 100 in the RRC connected state, but also by the UE 100 in the RRC idle state or the RRC inactive state, and is a delivery mode for low QoS requirements. The second delivery mode is used for broadcast sessions among MBS sessions. However, the second delivery mode may also be applicable to multicast sessions.

An MBS reception configuration in the second delivery mode is performed through broadcast signaling. For example, the MBS reception configuration in the second delivery mode is performed using a logical channel transmitted from the gNB 200 to the UE 100 through broadcast, for example, a broadcast control channel (BCCH) and/or a multicast control channel (MCCH). The UE 100 can receive the BCCH and the MCCH, using a dedicated RNTI defined in technical specifications in advance, for example. The RNTI for BCCH reception may be an SI-RNTI, and the RNTI for MCCH reception may be an MCCH-RNTI.

In the second delivery mode, the UE 100 may receive the MBS data in the following three procedures. First, the UE 100 receives MCCH configuration information via an SIB (MBS SIB) transmitted from the gNB 200 on the BCCH. Second, the UE 100 receives the MCCH from the gNB 200, based on the MCCH configuration information. On the MCCH, MTCH configuration information is transmitted. Third, the UE 100 receives the MTCH (MBS data), based on the MTCH configuration information. The MTCH configuration information and/or the MCCH configuration information may be hereinafter referred to as the MBS reception configuration.

In the first delivery mode and the second delivery mode, the UE 100 may receive the MTCH, using a group RNTI (G-RNTI) assigned from the gNB 200. The G-RNTI corresponds to an RNTI for MTCH reception. The MBS reception configuration (MTCH configuration information) may include the G-RNTI.

The network can provide different MBS services for different MBS sessions. The MBS session is identified by at least one selected from the group consisting of a Temporary Mobile Group Identity (TMGI), a source-specific IP multicast address (which includes a source unicast IP address, such as an application function and an application server, and an IP multicast address indicating a destination address), a session identifier, and a G-RNTI. At least one selected from the group consisting of the TMGI, the source specific IP multicast address, and the session identifier is referred to as an MBS session identifier. The TMGI, the source-specific IP multicast address, the session identifier, and the G-RNTI are collectively referred to as MBS session information.

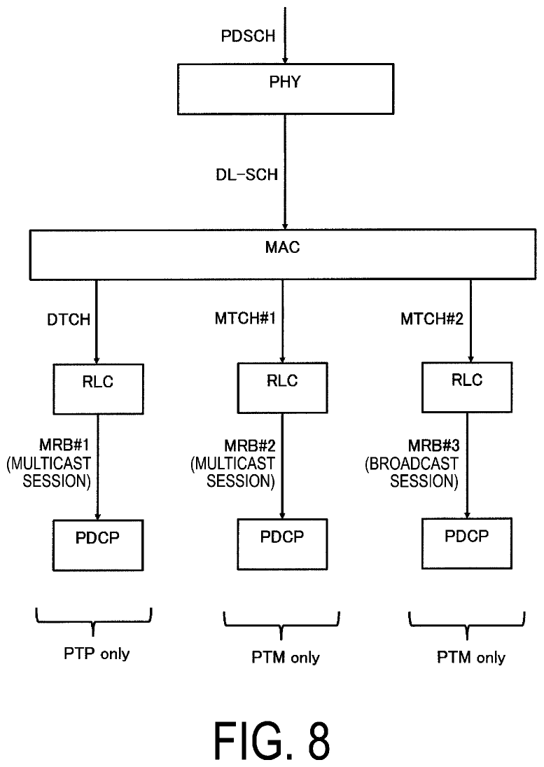

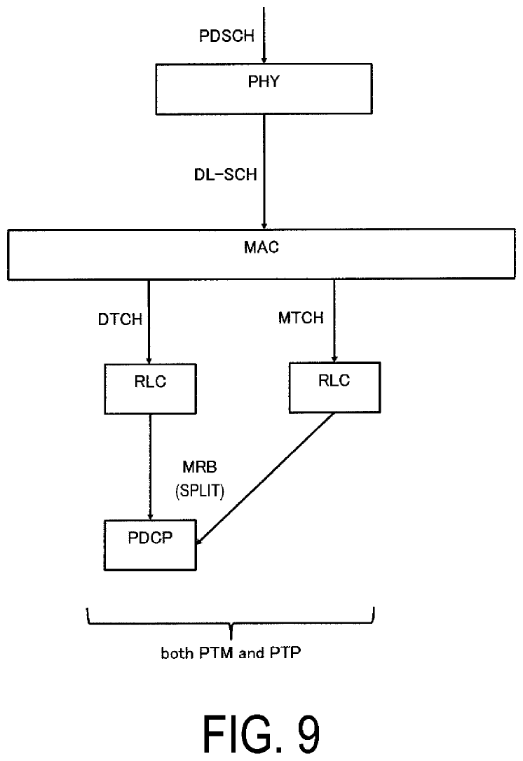

FIG. 8 is a diagram illustrating an example of internal processing related to MBS reception of the UE 100 according to the embodiment. FIG. 9 is a diagram illustrating another example of the internal processing related to the MBS reception of the UE 100 according to the embodiment.

One MBS radio bearer (MRB) is one radio bearer transmitting a multicast session or a broadcast session. That is, a multicast session may be associated with an MRB or a broadcast session may be associated with an MRB.

The MRB and the corresponding logical channel (e.g., MTCH) are configured in the UE 100 from the gNB 200 through RRC signaling. An MRB configuration procedure may be separated from a data radio bearer (DRB) configuration procedure. In the RRC signaling, one MRB can be configured with “PTM only”, “PTP only”, or “both PTM and PTP”. Such a type of MRB may be changed by the RRC signaling.

FIG. 8 illustrates an example in which a multicast session and a dedicated traffic channel (DTCH) are associated with an MRB #1, a multicast session and an MTCH #1 are associated with an MRB #2, and a broadcast session and an MTCH #2 are associated with an MRB #3. That is, the MRB #1 is a PTP only MRB, the MRB #2 is a PTM only MRB, and the MRB #3 is a PTM only MRB. Note that the DTCH is scheduled using a cell RNTI (C-RNTI). The MTCH is scheduled using the G-RNTI.

The PHY layer of the UE 100 processes user data (received data) received on the PDSCH, which is one of physical channels, and routes the processed user data to the downlink shared channel (DL-SCH), which is one of transport channels. The MAC layer (MAC entity) of the UE 100 processes the data received on the DL-SCH and routes the received data to a corresponding logical channel (corresponding RLC entity) based on a logical channel identifier (LCID) included in the header (MAC header) included in the received data.

FIG. 9 illustrates an example in which the DTCH and the MTCH are associated with the MRB associated with the multicast session. Specifically, one MRB is split into two legs, one leg is associated with the DTCH, and the other leg is associated with the MTCH. The two legs are combined at the PDCP layer (PDCP entity). That is, the MRB is an MRB configured with both PTM and PTP. Such an MRB may be referred to as a split MRB.

### MBS Interest Indication

The UE 100 that is receiving or is interested in receiving an MBS session in the RRC connected state can transmit an MBS Interest Indication (MII) to the serving cell (gNB 200). The MBS interest indication may be transmitted via a UE Assistance Information message, which is a type of RRC message. The MBS interest indication may be transmitted via a newly defined message (MBS interest indication message).

For example, the UE 100 starts an MBS interest indication procedure at a time of success of connection establishment, a time of entering or leaving a broadcast service area, a time of starting or stopping an MBS broadcast session, a time of change in MBS interest, a time of change in priority between MBS broadcast reception and unicast reception, and a time of change to a cell (primary cell) broadcasting an SIB for MBS service continuity.

The MBS interest indication may include at least one selected from the group consisting of an MBS frequency list, which is a list of MBS frequencies that the LE 100 is receiving or is interested in receiving, priority information indicating whether to prioritize reception of all the listed MBS frequencies or reception of a unicast bearer, and a TMGI list, which is a list of MBS sessions that the UE 100 is receiving or is interested in receiving.

### BWP

In 5G/NR, a Bandwidth Part (BWP) is defined for power consumption saving of the UE 100 and efficient use of a broadband carrier. The UE 100 configured with the BWP can perform communication in a frequency band having a bandwidth narrower than that of a cell. The BWP includes an initial BWP (initial DL BWP and initial UL BWP) and a dedicated BWP (dedicated DL BWP and dedicated UL BWP). DL refers to downlink and UL refers to uplink. The initial BWP is a BWP used at least for initial access and is commonly used by a plurality of UEs 100. The dedicated BWP is a BWP configured to be dedicated (UE-specific) to a certain UE 100. Up to four DL BWPs and up to four UL BWPs are configured in the UE 100 according to its capability in a certain serving cell. Note that, in the following description, the DL BWP and the UL BWP are simply referred to as a BWP when not distinguished from each other.

The initial BWP is a BWP used at least for initial access and is commonly used by a plurality of UEs 100. In each of the initial DL BWP and the initial UL BWP, a bwp-id, which is a BWP identifier, is defined as “0”. There are two types of initial BWPs: an initial BWP derived and configured by a master information block (MIB) carried on a PBCH, and an initial BWP configured by a system information block (SIB), specifically, a system information block type 1 (SIB1). The UE 100 uses the initial BWP configured by the MIB, that is, the bandwidth based on CORESET #0 for the initial BWP until reception of Message 4 (MSG4) in a random access procedure of initial access. After receiving MSG4, the UE 100 uses the bandwidth configured by the locationAndBandwidth in SIB1 for the initial BWP. Note that MSG4 may be an RRC Setup message, an RRC Resume message, or an RRC Reestablishment message. Through such initial access (random access procedure), the UE 100 transitions, for example, from the RRC idle state to the RRC connected state.

The dedicated BWP is a BWP configured to be dedicated (UE-specific) to a certain UE 100. A bwp-id other than “0” may be configured in the dedicated BWP. For example, the dedicated DL BWP and the dedicated UL BWP are respectively configured based on BWP-Downlink and BWP-Uplink, which are information elements included in ServingcellConfig in an RRC message, which is dedicated signaling transmitted from the gNB 200 to the UE 100.

The gNB 200 can notify the UE 100 of a BWP to be used for communication with the gNB 200 (i.e., active BWP) among the configured one or more BWPs. For example, the gNB 200 can transmit, to the UE 100, a BWP identifier indicating a BWP to be activated at a time of executing a configuration, i.e., a BWP to be used first in communication with the gNB 200. For example, a PDCCH (DCI), RRC signaling, a MAC control element (MAC CE), or switching by a timer is used for control of switching from an active BWP to a BWP that is not the active BWP (hereinafter referred to as an inactive BWP) and switching from the inactive BWP to the active BWP.

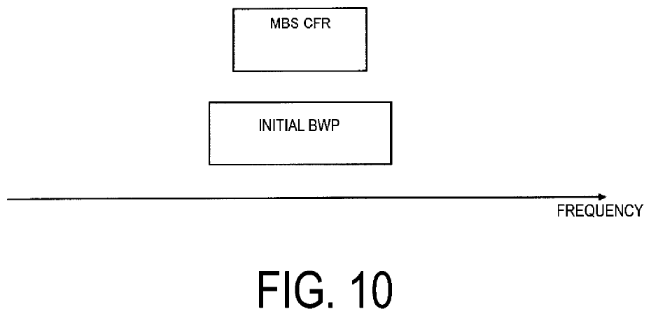

In consideration of such a BWP operation, an MBS common frequency resource (CFR) in which a plurality of UEs 100 can commonly perform MBS reception is introduced in the MBS. FIG. 10 is a diagram for describing the CFR. As illustrated in FIG. 10, for broadcast session reception supporting all the RRC states, a CFR for receiving a PDCCH and a PDSCH (i.e., MCCH and MTCH) common to broadcast sessions is preferably limited within the initial BWP. However, the bandwidth of the CFR may be equal to, smaller than, or larger than the bandwidth of the initial BWP (or CORESET #0). The CFR may partially overlap the initial BWP (or CORESET #0), may entirely overlap the initial BWP (or CORESET #0), or may not entirely overlap the initial BWP (or CORESET #0).

### Operation of Mobile Communication System

A scenario is assumed where the UE 100 that is receiving or is interested in receiving a broadcast session in the RRC idle state or the RRC inactive state transitions to the RRC connected state. The above-described second delivery mode is applied to this scenario. Note that, in the following description, a BWP mainly means a DL BWP.

When the UE 100 transitions to the RRC connected state, a dedicated BWP may be configured from the gNB 200. For example, when the UE 100 transitions from the RRC inactive state to the RRC connected state, the dedicated BWP may be configured from the gNB 200 by MSG4 (RRC Resume) of a random access procedure. When the UE 100 transitions from the RRC idle state to the RRC connected state, the dedicated BWP may be configured from the gNB 200 by an RRC Reconfiguration after the random access procedure.

Since the gNB 200 does not receive an MBS interest indication from the UE 100 during the random access procedure, the gNB 200 cannot recognize MBS interest of the UE 100. Thus, the gNB 200 may configure a dedicated BWP not covering a CFR in the UE 100 that is receiving or is interested in receiving a broadcast session. When the dedicated BWP not covering the CFR is configured in the UE 100, there is such a problem that the UE 100 cannot receive the broadcast session.

A security configuration of the UE 100 is not activated during the random access procedure. Thus, it is difficult for the UE 100 to transmit the MBS interest indication during the random access procedure. Specifically, since a TMGI list in the MBS interest indication may correspond to personal information for which security is required, it is conceivable that transmission of the TMGI list is not allowed before the security configuration is activated.

After the security configuration of the UE 100 is activated, the MBS interest indication is transmitted from the UE 100 to the gNB 200, so that the gNB 200 can recognize the MBS interest of the UE 100, configures a dedicated BWP covering a CFR for the UE 100, and activate the dedicated BWP. However, before the security configuration of the UE 100 is activated, the UE 100 cannot receive the desired broadcast session.

Thus, the UE 100 according to the embodiment performs the following operation. First, the UE 100 receives a broadcast session provided in a CFR (or initial BWP) of the serving cell or is interested in the reception when the UE 100 is in the RRC idle state or the RRC inactive state in the serving cell. Second, when transitioning from the RRC idle state or the RRC inactive state to the RRC connected state, the UE 100 transmits an MBS interest indication regarding the broadcast session to the serving cell (specifically, the gNB 200 managing the serving cell). The MBS interest indication does not include an MBS session identifier (TMGI) indicating the broadcast session and includes frequency information regarding the CFR (or initial BWP).

In this way, the UE 100 transmits the MBS interest indication not including the TMGI to the serving cell when transitioning to the RRC connected state and thus can transmit the MBS interest indication to the gNB 200 at an early stage before activation of a security configuration. For example, the UE 100 transmits the MBS interest indication via MSG3 or MSG5 of a random access procedure. In the case of transition from the RRC inactive state to the RRC connected state, MSG3 may be an RRC Resume Request message and MSG5 may be an RRC Resume Complete message. In the case of transition from the RRC idle state to the RRC connected state, MSG3 may be an RRC Setup Request message and MSG5 may be an RRC Setup Complete message. Since the MBS interest indication includes the frequency information regarding the CFR (or initial BWP), it is easy for the gNB 200 to configure, in the UE 100, the initial BWP or the dedicated BWP covering the CFR. As a result, the UE 100 can receive the broadcast session in the CFR.

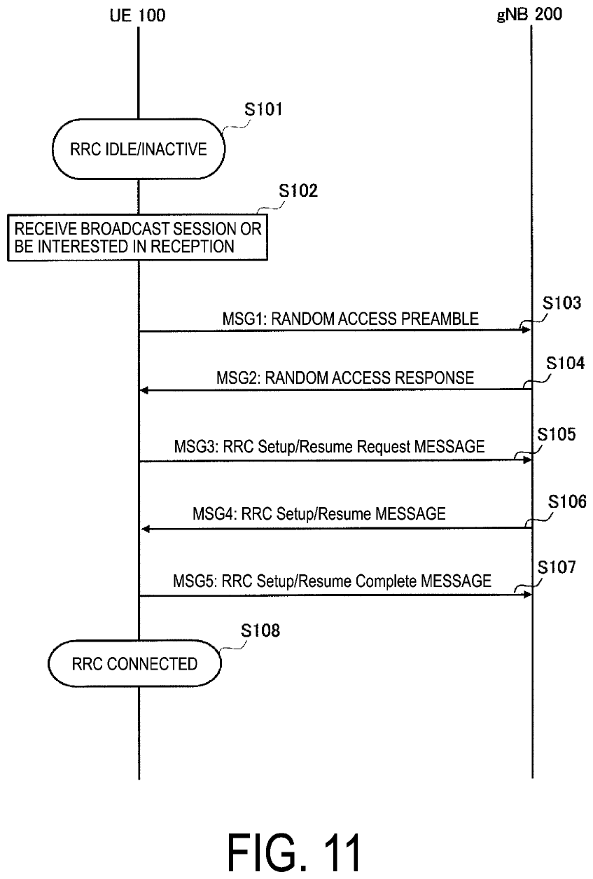

FIG. 11 is a diagram illustrating an operation example of the mobile communication system 1 according to the embodiment.

In step S101, the UE 100 is in the RRC idle state or the RRC inactive state. The UE 100 uses an initial BWP configured from the gNB 200.

In step S102, the UE 100 in the RRC idle state or the RRC inactive state receives or is interested in receiving a broadcast session. When receiving the broadcast session, the UE 100 receives an MCCH and an MTCH transmitted in a CFR.

In step S103, the UE 100 starts a random access procedure and transmits a random access preamble (MSG1) to the gNB 200.

In step S104, the gNB 200 transmits a random access response (MSG2) to the UE 100 upon receipt of the random access preamble (MSG1).

In step S105, the UE 100 transmits an RRC Setup Request message or an RRC Resume Request message (MSG3) to the gNB 200 upon receipt of the random access response (MSG2).

In step S106, the gNB 200 transmits an RRC Setup message or an RRC Resume message (MSG4) to the UE 100 upon receipt of the RRC Setup Request message or the RRC Resume Request message (MSG3).

In step S107, the UE 100 transmits an RRC Setup Complete message or an RRC Resume Complete message (MSG5) to the gNB 200 upon receipt of the RRC Setup message or the RRC Resume message (MSG4). Note that MSG1 to MSG5 constitute the random access procedure.

In step S108, the UE 100 transitions to the RRC connected state through such a random access procedure.

In the random access procedure, the UE 100 transmits an MBS interest indication regarding the broadcast session that the UE 100 is receiving or is interested in receiving to the gNB 200 via MSG3 or MSG5. The MBS interest indication may not include an MBS session identifier (TMGI) indicating the broadcast session and may include frequency information regarding the CFR (or initial BWP). The frequency information includes at least one selected from the group consisting of an identifier of the initial BWP, an identifier of the common frequency resource, an identifier indicating a frequency or a resource block corresponding to the initial BWP, and an identifier indicating a frequency or a resource block corresponding to the common frequency resource. The identifier indicating the frequency may be an Absolute radio-frequency channel number (ARFCN) (and bandwidth). The identifier indicating the resource block may be a resource block number (and the number of resource blocks). The gNB 200 may configure (and activate) the initial BWP or a dedicated BWP covering the CFR in the UE 100 via MSG4 or an RRC Reconfiguration message based on such frequency information. Even when the MBS interest indication does not include the frequency information, the gNB 200 can recognize that the UE 100 is receiving (or is interested in receiving) the broadcast session, so that it is possible to take measures of, for example, refraining from configuring the dedicated BWP.

The UE 100 may transmit the MBS interest indication to the gNB 200 via MSG5 (RRC Setup Complete message or RRC Resume Complete message). When the UE 100 already has a content (such as frequency information) to be reported in the MBS interest indication and the UE 100 is receiving the MBS session (broadcast session), the UE 100 may transmit the MBS interest indication to the gNB 200 via MSG5 (RRC Setup Complete message or RRC Resume Complete message). The MBS interest indication may include a list of MBS frequencies that the UE 100 is receiving or is interested in receiving (MBS frequency list) as the frequency information. The MBS interest indication may include priority information indicating whether to prioritize reception of the MBS frequencies in the list or reception of a unicast bearer. The gNB 200 may configure (and activate) the initial BWP or the dedicated BWP covering the CFR in the UE 100 based on the MBS interest indication. Alternatively, the gNB 200 may perform control so as not to configure (or activate) the dedicated BWP in the UE 100 based on the MBS interest indication. The MBS interest indication may be transmitted via the same message as Msg3 or Msg5. In this case, the MBS interest indication may be encapsulated in Msg3 or Msg5 and transmitted, or an information element of the MBS interest indication may be stored in Msg3 or Msg5 and transmitted. The MBS interest indication may be transmitted at the same timing as Msg3 or Msg5. In this case, the MBS interest indication is transmitted as a message different from Msg3 or Msg5.

### Variation 1 of Operation of Mobile Communication System

In the above-described embodiment, a scenario has been assumed in which the UE 100 receives a broadcast session provided from the serving cell. However, the UE 100 may receive a broadcast session provided from a non-serving cell (neighboring cell). When the broadcast session is received from the non-serving cell, reception of the broadcast session is not affected even if a dedicated BWP not covering a CFR is configured in the serving cell.

In the present variation, the UE 100 operates as follows. First, the UE 100 receives or is interested in receiving a broadcast session when the UE 100 is in the RRC idle state or the RRC inactive state in the serving cell. Second, when the broadcast session is provided from the serving cell, the UE 100 transmits an MBS interest indication regarding the broadcast session to the serving cell at a time of transition from the RRC idle state or the RRC inactive state to the RRC connected state. When the broadcast session is provided from a non-serving cell (neighboring cell), the UE 100 omits transmitting the MBS interest indication to the serving cell at a time of transition to the RRC connected state.

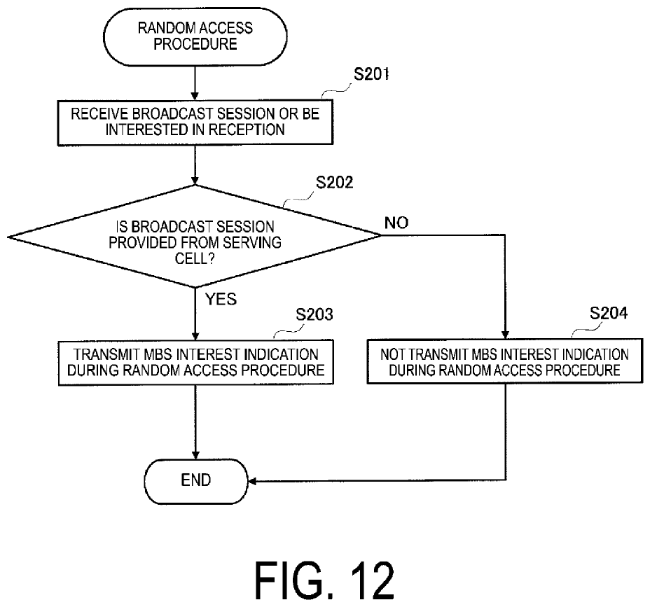

FIG. 12 is a diagram illustrating an operation example of the UE 100 according to the present variation.

In step S201, the UE 100 in the RRC idle state or the RRC inactive state receives or is interested in receiving a broadcast session. The UE 100 may identify, based on neighboring cell information included in an MCCH, a neighboring cell providing the broadcast session (TMGI) in which the UE 100 is interested.

In step S202, the UE 100 determines whether the broadcast session that the UE 100 is receiving or is interested in receiving is provided from the serving cell.

When the broadcast session is provided from the serving cell (YES in step S202), the UE 100 transmits an MBS interest indication to the serving cell (gNB 200) during a random access procedure in step S203. The UE 100 may transmit the MBS interest indication to the serving cell based on a determination criterion that the broadcast session can be received only from the serving cell. Examples of a case where the broadcast session can be received only from the serving cell include a case where the broadcast session is provided only from the serving cell and a case where the broadcast session cannot be received from the non-serving cell depending on the capability of the UE 100. The MBS interest indication may be an MBS interest indication same as and/or similar to that of the embodiment described above. In the present variation, the MBS interest indication may be flag information indicating that the UE 100 is receiving or is interested in receiving the broadcast session. The MBS interest indication may be transmitted to the serving cell via MSG1. For example, the MBS interest indication may be a special preamble sequence indicating that the UE 100 is receiving or is interested in receiving the broadcast session or a random access preamble transmitted in a special PRACH resource.

On the other hand, when the broadcast session that the UE 100 is receiving or is interested in receiving is provided from the non-serving cell (neighboring cell) (NO in step S202) or when the broadcast session can be received from the non-serving cell, the UE 100 does not transmit the MBS interest indication to the serving cell (gNB 200) during the random access procedure in step S204.

### Variation 2 of Operation of Mobile Communication System

In the present variation, the UE 100 does not apply a configuration of a dedicated BWP from the serving cell (gNB 200), thereby enabling reception of a broadcast session in an initial BWP (CFR).

Specifically, in the present variation, the UE 100 operates as follows. First, the UE 100 receives or is interested in receiving a broadcast session transmitted in a CFR (or initial BWP) of the serving cell when the UE 100 is in the RRC idle state or the RRC inactive state in the serving cell. Second, when the UE 100 transitions from the RRC idle state or the RRC inactive state to the RRC connected state, the UE 100 receives, from the serving cell, a message (MSG4 or RRC Reconfiguration message) for configuring, in the UE 100, a dedicated BWP different from the CFR (or initial BWP). Third, the UE 100 continues use of the initial BWP (or receive the broadcast session in the CFR) without applying the configuration of the dedicated BWP even when the message is received. The UE 100 may transmit, to the serving cell, a notification indicating that the configuration of the dedicated BWP by the message is not applied.

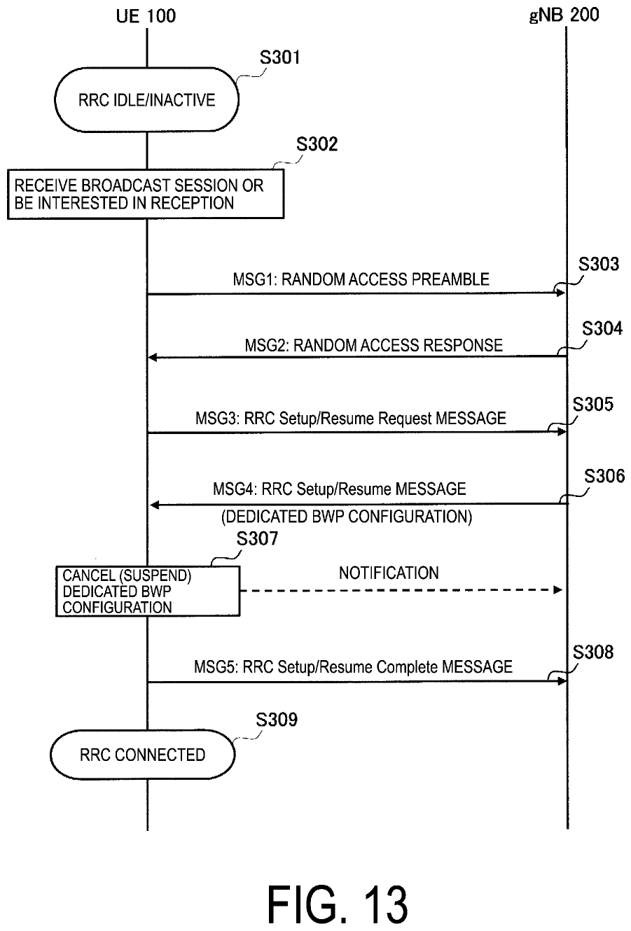

FIG. 13 is a diagram illustrating an operation example of the mobile communication system 1 according to the present variation. Although an example in which the message used for configuring the dedicated BWP is MSG4 will be described, the message used for configuring the dedicated BWP may be an RRC Reconfiguration message.

In step S301, the UE 100 is in the RRC idle state or the RRC inactive state. The UE 100 uses an initial BWP configured from the gNB 200.

In step S302, the UE 100 in the RRC idle state or the RRC inactive state receives or is interested in receiving a broadcast session. When receiving the broadcast session, the UE 100 receives an MCCH and an MTCH transmitted in a CFR.

In step S303, the UE 100 starts a random access procedure and transmits a random access preamble (MSG1) to the gNB 200.

In step S304, the gNB 200 transmits a random access response (MSG2) to the UE 100 upon receipt of the random access preamble (MSG1).

In step S305, the UE 100 transmits an RRC Setup Request message or an RRC Resume Request message (MSG3) to the gNB 200 upon receipt of the random access response (MSG2).

In step S306, the gNB 200 transmits an RRC Setup message or an RRC Resume message (MSG4) to the UE 100 upon receipt of the RRC Setup Request message or the RRC Resume Request message (MSG3). The gNB 200 configures a dedicated BWP in the UE 100.

In step S306, the UE 100 suspends (or cancels) the dedicated BWP configuration when the UE 100 cannot receive the broadcast session in the dedicated BWP, i.e., when the dedicated BWP does not cover the CFR. The UE 100 may maintain an initial BWP in an active state.

The UE 100 may notify the gNB 200 that the dedicated BWP configuration is suspended. The UE 100 may notify the gNB 200 that the initial BWP is maintained in the active state. Such a notification may be an RRC message (MBS interest indication, UAI, or the like) or may be a MAC CE (Control Element). The notification may include an identifier of the suspended BWP. The notification may include an identifier of the actually applied BWP (initial BWP or the like).

When recognizing that the dedicated BWP configuration is suspended based on the notification, the gNB 200 does not perform transmission and reception using the dedicated BWP (does not activate the dedicated BWP).

In step S307, the UE 100 transmits an RRC Setup Complete message or an RRC Resume Complete message (MSG5) to the gNB 200 upon receipt of the RRC Setup message or the RRC Resume message (MSG4).

In step S308, the UE 100 transitions to the RRC connected state through the random access procedure.

Note that the UE 100 may transmit an MBS interest indication including an MBS session identifier (TMGI) to the gNB 200 after activation of a security configuration (security activation). As a result, the gNB 200 may de-configure the dedicated BWP from the UE 100.

### Variation 3 of Operation of Mobile Communication System

In the above-described embodiment, it is mainly assumed that the gNB 200 configures a dedicated BWP in the UE 100. In the present variation, it is mainly assumed that the gNB 200 configures carrier aggregation in the UE 100. As described above, the UE 100 may receive a broadcast session from a non-serving cell (neighboring cell). Thus, when the gNB 200 can recognize the non-serving cell (neighboring cell) providing the broadcast session that the UE 100 is receiving or is interested in receiving, it is easy for the gNB 200 to configure the non-serving cell (neighboring cell) as a part of carrier aggregation (specifically, a secondary cell).

Specifically, in the present variation, the UE 100 operates as follows. First, the UE 100 receives an MBS session (e.g., broadcast session) provided in a neighboring cell or is interested in the reception when the UE 100 is in the RRC idle state or the RRC inactive state in the serving cell. Second, at a time of transition from the RRC idle state or the RRC inactive state to the RRC connected state, an MBS interest indication regarding the MBS session is transmitted to the serving cell. The MBS interest indication does not include an MBS session identifier (TMGI) and includes a cell identifier of the neighboring cell. When transmitting MSG5 (RRC Setup Complete message or RRC Resume Complete message) to the serving cell, the UE 100 may transmit the MBS interest indication including the cell identifier of the neighboring cell to the serving cell.

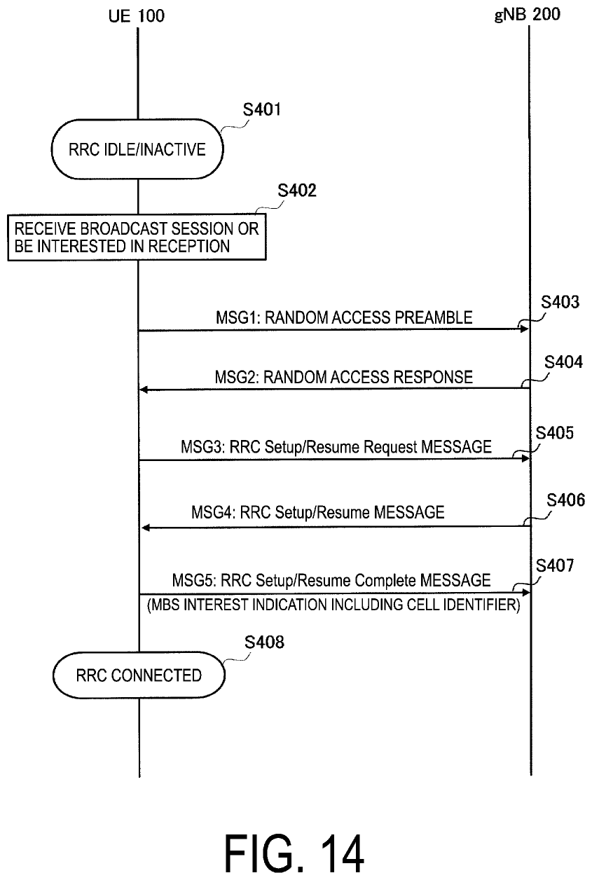

FIG. 14 is a diagram illustrating an operation example of the mobile communication system 1 according to the present variation.

In step S401, the UE 100 is in the RRC idle state or the RRC inactive state. The UE 100 uses an initial BWP configured from the gNB 200.

In step S402, the UE 100 in the RRC idle state or the RRC inactive state receives or is interested in receiving a broadcast session. The UE 100 may identify, based on neighboring cell information included in an MCCH, a neighboring cell providing the broadcast session (TMGI) in which the UE 100 is interested.

In step S403, the UE 100 starts a random access procedure and transmits a random access preamble (MSG1) to the gNB 200.

In step S404, the gNB 200 transmits a random access response (MSG2) to the UE 100 upon receipt of the random access preamble (MSG1).

In step S405, the UE 100 transmits an RRC Setup Request message or an RRC Resume Request message (MSG3) to the gNB 200 upon receipt of the random access response (MSG2).

In step S406, the gNB 200 transmits an RRC Setup message or an RRC Resume message (MSG4) to the UE 100 upon receipt of the RRC Setup Request message or the RRC Resume Request message (MSG3).

In step S407, the UE 100 transmits an RRC Setup Complete message or an RRC Resume Complete message (MSG5) to the gNB 200 upon receipt of the RRC Setup message or the RRC Resume message (MSG4). The UE 100 transmits, to the gNB 200, an MBS interest indication including a cell identifier of the neighboring cell providing the broadcast session that the UE 100 is receiving or is interested in receiving. The MBS interest indication does not include a TMGI.

In step S408, the UE 100 transitions to the RRC connected state through the random access procedure. When the gNB 200 configures carrier aggregation in the UE 100 via a first RRC Reconfiguration for the UE 100, the gNB 200 may configure, for the UE 100, the neighboring cell of which the gNB 200 has been notified through the MBS interest indication as a secondary cell.

Although the MBS interest indication transmitted during the random access procedure has been mainly described in the present variation, the MBS interest indication including the cell identifier may be able to be transmitted by the UE 100 even after the random access procedure. In that case, the MBS interest indication may include an MBS session identifier (TMGI).

### OTHER EMBODIMENTS

In the above embodiment and the variations thereof, the random access procedure may be a two-step random access procedure. In the two-step random access procedure, the UE 100 may transmit, to the gNB 200, a set of a random access preamble (MSG1) and the above-described MSG3 as MSGA. The gNB 200 may transmit, to the UE 100, a set of a random access response (MSG2) and the above-described MSG4 as MSGB.

The operation flows described above can be separately and independently implemented, and also be implemented in combination of two or more of the operation flows. For example, some steps of one operation flow may be added to another operation flow or some steps of one operation flow may be replaced with some steps of another operation flow.

In the embodiment and example described above, an example in which the base station is an NR base station (i.e., a gNB) has been described; however, the base station may be an LTE base station (i.e., an eNB) or a 6G base station. The base station may be a relay node such as an Integrated Access and Backhaul (IAB) node. The base station may be a DU of the IAB node. The UE 100 may be a Mobile Termination (MT) of the IAB node.

A program causing a computer to execute each processing performed by the UE 100 or the gNB 200 may be provided. The program may be recorded in a computer readable medium. Use of the computer readable medium enables the program to be installed on the computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be configured as a semiconductor integrated circuit (chipset, System on a chip (SoC)).

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain/acquire information from stored information, may mean to obtain/acquire information from information received from another node, or may mean to obtain/acquire information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

The embodiment has been described above in detail with reference to the drawings, but specific configurations are not limited to those described above, and various design variation can be made without departing from the gist of the present disclosure.

### Supplementary Note

### 1. Introduction

The revised work item for NR Multicast and Broadcast Services (MBS) has been approved in RAN #88. In RAN2 #116e, there has been significant progress in the details of the MBS interest indication (MII).

In this supplementary note, the remaining problems related to the MBS interest indication are considered.

### 2. Discussion

### 2.1. Definition of Message

The currently running CR of TS38.331 incorporates the following matters that require further considerations.

A further study is necessary regarding whether an MII (MBMS interest indication) is reported via UE Assistance Information or a new RRC message and whether MII information uses a separate IE and is included directly in an RRC message structure.

In LTE, the MBMS interest indication (MII) is separated from the UE Assistance Information (UAI). This is because the preconditions of obtaining an SIB15 in the MII and an RRC Connection Reconfiguration in the UAI are different. On the other hand, an In-device Coexistence Indication (IDC), which is a separate message in LTE, is integrated into the UAI in NR. This is considered feasible in LTE (and NR) because the preconditions for the IDC and the UAI are the same, i.e., RRC Connection Reconfiguration.

Observation 1: Whether the MBS interest indication can be integrated with the UE Assistance Information depends on whether the preconditions match between the two messages.

In the NR MBS, neighboring frequency information in an SIB is needed for generation of an MBS interest indication message including the above IE. When the UE can obtain the SIB from the serving cell, transmission of the MBS interest indication is permitted, which is already understood under the condition that “the SIB×1 is broadcast from the PCell” in the approved CR, in a manner same as and/or similar to the LTE eMBMS. Thus, it does not match an RRC Reconfiguration, which is a precondition of the UAI. Thus, the MBS interest indication needs to be a separate message from the UAI, like the LTE eMBMS.

Proposal 1: RAN2 needs to agree to define the MBS interest indication as a new message, i.e., separately from the UAI.

Proposal 2: RAN2 needs to agree that transmission of the MBS interest indication is permitted when the UE can acquire an MBS-specific SIB (i.e., SIB×1) from the serving cell (i.e., as a precondition).

### 2.2. Other Triggers and Network Control

The following matters that require further considerations are incorporated into the currently running CR.

Other triggers and network control need to be further studied.

RAN2 #116e has agreed on various triggers for the MBS interest indication.

It is confirmed that the UE can start an MII procedure at a time of success of connection establishment, a time entering or leaving a broadcast service area, a time of starting or stopping an MBS broadcast session, a time of change in interest, a time of change in priority order between MBS broadcast reception and unicast reception, or a time of change to a PCell broadcasting an SIB×1. Other triggers and network control need to be further studied.

For an additional trigger, it is considered to be necessary to transmit the IBS interest indication at a time of change in a frequency list. RAN2 #116e has agreed on a detailed operation of a method of configuring a frequency of interest as follows.

During the MII, the UE needs to report only a set of MBS frequencies that the UE can simultaneously receive. That is, the UE supports at least one band combination and can receive an indicated set of frequencies.

The UE does not consider the currently configured serving frequency when evaluating frequencies that can be simultaneously received for reporting using the MI. That is, only the IBS frequency of interest for reception is considered, regardless of whether it is possible to perform reception together with the current serving cell.

According to the above agreement, when carrier aggregation configuration is updated (such as addition or deletion of the SCell), it may affect a bandwidth combination in which the UE can currently operate and thus a frequency list may be changed. In this case, when the list is different from the frequency list that has been reported in the previous MBS interest indication, it may be necessary to report the latest frequency of interest to the serving cell. Thus, RAN2 needs to consider whether to transmit the MBS interest indication when the frequencies of the serving cell and the non-serving cell are changed due to configuration change of the serving cell.

Proposal 3: RAN2 needs to consider whether to transmit the MBS interest indication when the frequency of interest of the UE is changed due to configuration change of the serving cell.

Network control is certainly useful if it is possible to manage transmission of MBS interest indications from a large number of UEs in order to avoid network congestion. Problems that cause resource overload include a “spike” in the number of MBS interest indications and “frequent” MBS interest indications.

Observation 2: Network congestion may occur due to a spike in the number of MBS interest indications from a large number of UEs or frequent MBS interest indications from a certain UE.

When a large number of UEs simultaneously transmit MBS interest indications, a spike in transmission occurs. Since this is a common event for all UEs interested in an MBS broadcast session, a possible trigger for causing this problem may be “start or stop an MBS broadcast session”. In particular, when the session is stopped, the gNB already knows that the MBS broadcast session has been stopped by the CN and thus can determine that the UE has lost interest in this TMGI without the MBS interest indication. In view of these scenarios, conceivable network control is to spread the MBS interest indications in a time domain and/or frequency domain (e.g., session start) or to turn on/off the MBS interest indications during this event (e.g., session stop).

Frequent transmission occurs when the UE frequently changes interest due to user preference, etc. Conceivable triggers for causing this problem include “change in interest” and “change in priority between MBS broadcast reception and unicast reception”. Conceivable network control includes configuring a prohibition timer in the UE.

Other triggers, i.e., “success of connection establishment”, “entering or leaving a broadcast service area”, and “change to a PCell broadcasting an SIB×1” are considered to cause no major problems since these triggers are sufficiently made random (in terms of time) or already controlled by the network.

In light of the above discussion, it has been confirmed that different triggers may require different control methods, i.e., spreading, turning on/off, and prohibition timer, and yet other triggers may not require any enhancement. Thus, RAN2 needs to discuss whether to consider network control, and if so, which trigger requires what kind of network control.

Proposal 4: RAN2 needs to discuss network control for suppressing a spike in transmission of MBS interest indications and frequent transmission of MBS interest indications by the UE.

Proposal 5: RAN2 needs to discuss whether to apply different network control methods to different triggers of MBS interest indications.

### 2.3. Early Notification for Improving BWP Switching Operation

This consideration is incorporated into the currently running CR based on the RAN2 agreement that “the MBS interest indication is transmitted after security activation (it can still be discussed whether additional optimization is needed for a better BWP switching operation)”.

Whether additional optimization is needed for improvement of a BWP switching operation needs to be further studied.

Whether further optimization is needed for a better BWP switching operation needs to be further studied.

A problem regarding service continuity occurs when the UE transitions to the connected state. Specifically, when the serving cell configures a dedicated BWP inconsistent with a CFR in the UE, the UE cannot continuously receive a broadcast session. Although such configuration can be avoided after the MBS interest indication, a problem arises due to configuration performed before the MBS interest indication, i.e., before AS security activation.

It is pointed out that the UE in the inactive state can configure a dedicated BWP via Msg4 (RRC Resume), and it is proposed to provide a 1-bit indication in Msg3 to notify the serving cell that the UE is receiving an MBS broadcast session. The serving cell has a UE context for the UE in the inactive state and the UE context includes a previously reported MBS interest indication. Although this is not the latest interest information, the serving cell is expected to predict whether the UE transitioning from the inactive state to the connected state is receiving a broadcast session. Thus, it is not important to extend Msg3 in consideration of a limited message size.

It is proposed to introduce an early “broadcast reception” indication of Msg5, which is information for configuring a dedicated BWP by the serving cell via the next RRC Reconfiguration. This solution is a simple extension but still useful.

According to the LS from SA3, they are only concerned about reporting a TMGI list before AS security activation. It is explicitly mentioned that other information (frequency list and priority order information) can be reported before AS security activation. Thus, the UE is considered to be able to transmit the early MBS interest indication. The early MBS interest indication is transmitted together with Msg5 and includes the full contents other than the TMGI list, i.e., the frequency list and the priority order information instead of the above 1-bit indication. When the gNB receives the early MBS interest indication via Msg5, it can be determined whether this UE is receiving a broadcast session because the MBS interest indication is for the second delivery mode. Even if the TMGI in which the UE is interested is still unknown, the full contents may be useful for the gNB to determine appropriate configuration (e.g., SCell configuration) for different frequencies. Since these contents are finally reported after AS security activation, there is no signaling overhead if these contents are reported in the early MBS interest indication.

It is worth considering whether additional information is needed for the early MBS interest indication. For example, the UE reports a CFR receiving an MBS broadcast session of interest in the early MBS interest indication. For example, the gNB may use CFR information to determine an appropriate dedicated BWP such that such a CFR is part of the dedicated BWP. As another example, the UE reports a Cell ID in which the MBS broadcast session of interest is provided using the early MBS interest indication.

Proposal 6: RAN2 needs to study whether to transmit the early MBS interest indication together with Msg5 including the full contents other than a TMGI list, i.e., a frequency list and priority information.

Proposal 7: RAN2 needs to further discuss whether it is useful to report additional information in the early MBS interest indication, such as a CFR and a cell ID of interest.

### 2.4. MBS Interest Indication of Multicast Session

RAN2 currently assumes that the MBS interest indication is supported in broadcast sessions and not in multicast sessions. RAN2 #115e has agreed on the basic contents of the MBS interest indication, i.e., an MBS frequency list, priority, and TMGI list.

In a multicast session, it is commonly understood that the core network notifies the gNB of the interest of the UE because a session join procedure is in an upper layer. The interest of the UE is considered to apply to MBS services. The gNB may know the MBS frequency and the cell providing the MBS service of interest of the UE. However, the priority order between MBS reception and unicast, which is purely AS-related information, may not be provided from the core network. That is, it is strange for the UE to convey priority order information to the core network during the session join procedure.

Observation 3: For a multicast session, the core network provides the gNB with an MBS service of interest of the UE, and the gNB may know the MBS frequency/cell, but the core network and the gNB may not know AS priority of the UE between MBS and unicast.

Priority information, in a manner same as and/or similar to the LTE eMBMS, is also useful for the gNB, such as scheduling and handover determination, and may also be relevant to service continuity. Thus, the UE needs to notify the gNB of the priority information also for multicast sessions. In this sense, RAN2 needs to agree that the MBS interest indication needs to be supported for multicast service/first delivery mode.

Proposal 8: RAN2 needs to agree that the MBS interest indication is also supported for multicast session/first delivery mode, at least for the UE to notify the gNB of the priority order between MBS reception and unicast.

### REFERENCE SIGNS

1: Mobile communication system
10: RAN
20: CN
100: UE
110: Receiver
120: Transmitter
130: Controller
200: gNB
210: Transmitter
220: Receiver
230: Controller
240: Backhaul communicator

1. A communication method performed by a user equipment in a mobile communication system providing a multicast and broadcast service (MBS), the communication method comprising:
transmitting an MBS interest indication regarding an MBS session to a serving cell,
wherein
the MBS session is a broadcast session, and
the MBS interest indication does not include an MBS session identifier indicating the MBS session and includes information regarding common frequency resource for reception of the MBS session.

2. The communication method according to claim 1, wherein
the MBS interest indication comprises at least one selected from the group consisting of an identifier of an initial bandwidth part, an identifier of the common frequency resource, an identifier indicating a frequency or a resource block corresponding to the initial bandwidth part, and an identifier indicating a frequency or a resource block corresponding to the common frequency resource.

3. The communication method according to claim 1, wherein
the transmitting of the MBS interest indication comprises transmitting the MBS interest indication to the serving cell when transmitting an RRC Setup Complete message or an RRC Resume Complete message to the serving cell.

4. The communication method according to claim 1, wherein
the MBS interest indication comprises, as the frequency information, a list of MBS frequencies that the user equipment is receiving or is interested in receiving.

5. The communication method according to claim 4, wherein
the MBS interest indication further comprises priority information indicating whether to prioritize reception of the MBS frequencies in the list or reception of a unicast bearer.

6. The communication method according to claim 1, further comprising:
receiving or being interested in receiving the MBS session when in an RRC idle state or an RRC inactive state in the serving cell, wherein
the transmitting the MBS interest indication includes transmitting the MBS interest indication to the serving cell when transitioning from the RRC idle state or the RRC inactive state to an RRC connected state.

7. The communication method according to claim 6, wherein
the receiving or being interested in receiving of the MBS session comprises receiving or being interested in receiving the MBS session provided in a neighboring cell, and
the transmitting of the MBS interest indication comprises transmitting, to the serving cell, the MBS interest indication comprising the cell identifier of the neighboring cell when transmitting an RRC Setup Complete message or an RRC Resume Complete message to the serving cell.

8. A user equipment comprising:
a transmitter configured to transmit a multicast and broadcast service (MBS) interest indication regarding an MBS session to a serving cell, wherein
the MBS session is a broadcast session, and
the MBS interest indication does not include an MBS session identifier indicating the MBS session and includes information regarding common frequency resource for reception of the MBS session.

9. A network node comprising:
a receiver configured to receive a multicast and broadcast service (MBS) interest indication regarding an MBS session to a serving cell, wherein
the MBS session is a broadcast session, and
the MBS interest indication does not include an MBS session identifier indicating the MBS session and includes information regarding common frequency resource for reception of the MBS session.

10. A chipset for a user equipment, the chipset configured to execute processing of:
transmitting a multicast and broadcast service (MBS) interest indication regarding an MBS session to a serving cell, wherein
the MBS session is a broadcast session, and
the MBS interest indication does not include an MBS session identifier indicating the MBS session and includes information regarding common frequency resource for reception of the MBS session.

11. A non-transitory computer-readable medium comprising, stored thereupon, computer program instructions for execution by a user equipment, the program instructions being configured to cause the user equipment to execute processing of:
transmitting a multicast and broadcast service (MBS) interest indication regarding an MBS session to a serving cell, wherein
the MBS session is a broadcast session, and
the MBS interest indication does not include an MBS session identifier indicating the MBS session and includes information regarding common frequency resource for reception of the MBS session.

12. A mobile communication system providing a multicast and broadcast service (MBS), the mobile communication system comprising:
a user equipment configured to transmit an MBS interest indication regarding an MBS session to a serving cell, wherein
the MBS session is a broadcast session, and
the MBS interest indication does not include an MBS session identifier indicating the MBS session and includes information regarding common frequency resource for reception of the MBS session.
